(19) United States
(12) Patent Application Publication
(10) Pub. No.: US 2008/0010497 A1
(43) Pub. Date: Jan. 10, 2008

(54) Selecting a Logging Method via Metadata

(76) Inventors: Curtis Duane Kronlund, Cottage Grove, MN (US); Scot Alan Moore, Rochester, MN (US); Gregory Allan Olson, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(21) Appl. No.: 11/423,611

(22) Filed: Jun. 12, 2006

(51) Int. Cl. G06F 11/00

(52) U.S. Cl. 714/6

(57) ABSTRACT

In an embodiment, data and a specification of a default logging method are received from an application. If more than a threshold amount of metadata has been collected, then a logging method is selected based on the metadata and rules, and the data is saved via the selected logging method; otherwise, the data is saved via the default logging method. In various embodiments, the metadata describes the data, the performance of the computer system in which the saving is performed, the resources of the computer, or a reason for saving the data. A rule identifies a field in the metadata, a field threshold, and a rule logging method. If a value in the field in the metadata satisfies the field threshold in the rule, then the selected logging method is the rule logging method; otherwise, a different rule is chosen. In this way, an appropriate logging method for logging data may be selected.

### FIELD

This invention generally relates to computer systems and more specifically relates to selecting a logging method for logging data via metadata.

### BACKGROUND

The development of the EDVAC computer system of 1948 is often cited as the beginning of the computer era. Since that time, computer systems have evolved into extremely sophisticated devices, and computer systems may be found in many different settings. Computer systems typically include a combination of hardware, such as semiconductors and circuit boards, and software, also known as computer programs.

As computers have become more sophisticated and powerful, they have also become more complicated, which makes learning information about the use of the computer and events that have occurred within the computer more difficult. In an attempt to provide such information, many computers use data logging, which is the practice of systematic recording of data to a log, often but not always chronologically, in response to specific types of data processing events.

The contents and format of the logged data may vary widely based on the discretion of the process or device that creates the logged data and the event that is the impetus for the logging. The logged data often includes a timestamp and an indication of the type of data, the severity or importance of the event, and/or the reason for the logging. Types of the data may include status or informational messages, errors, exceptions, or traces of activity, among others. A variety of devices or processes may generate logged data, such as applications, operating systems, storage devices, printers, routers, hubs, switches, and workstations.

The developer of the device or process that creates the logged data typically selects a logging method or technique during a design or implementation phase of development. Different logging methods have different APIs (Application Program Interfaces), store the logged data in different formats, and have different performance characteristics. Once implemented, the selected logging method is static and does not change. Developers have a wide range of knowledge, experience, and skill, so the logging method chosen by the developer may not be optimal given how the process or device is actually used in a customer's environment. A non-optimal logging method may result in unnecessary overhead and poor performance.

Thus, a better way to select an appropriate logging method is needed.

### SUMMARY

A method, apparatus, system, and signal-bearing medium are provided. In an embodiment, data and a specification of a default logging method are received from an application. If more than a threshold amount of metadata has been collected, then a logging method is selected based on the metadata and rules, and the data is saved via the selected logging method; otherwise, the data is saved via the default logging method. In various embodiments, the metadata describes the data, the performance of the computer system in which the saving is performed, the resources of the computer, or a reason for saving the data. A rule identifies a field in the metadata, a field threshold, and a rule logging method. If a value in the field in the metadata satisfies the field threshold in the rule, then the selected logging method is the rule logging method; otherwise, a different rule is chosen. In this way, an appropriate logging method for logging data may be selected.

### BRIEF DESCRIPTION OF THE DRAWINGS

Various embodiments of the present invention are hereinafter described in conjunction with the appended drawings:

FIG. 1 depicts a high-level block diagram of an example system for implementing an embodiment of the invention.

FIG. 2 depicts a block diagram of example metadata, according to an embodiment of the invention.

FIG. 3 depicts a block diagram of example rules, according to an embodiment of the invention.

FIG. 4 depicts a block diagram of example logs, according to an embodiment of the invention.

FIG. 5 depicts a block diagram of an example merged log, according to an embodiment of the invention.

FIG. 6 depicts a block diagram of example logging methods, according to an embodiment of the invention.

FIG. 7 depicts a flowchart of example processing for a controller, according to an embodiment of the invention.

FIG. 8 depicts a flowchart of example processing for selecting a logging method by the controller, according to an embodiment of the invention.

FIG. 9 depicts a flowchart of example processing for merging and displaying logs by the controller, according to an embodiment of the invention.

It is to be noted, however, that the appended drawings illustrate only example embodiments of the invention, and are therefore not considered limiting of its scope, for the invention may admit to other equally effective embodiments.

### DETAILED DESCRIPTION

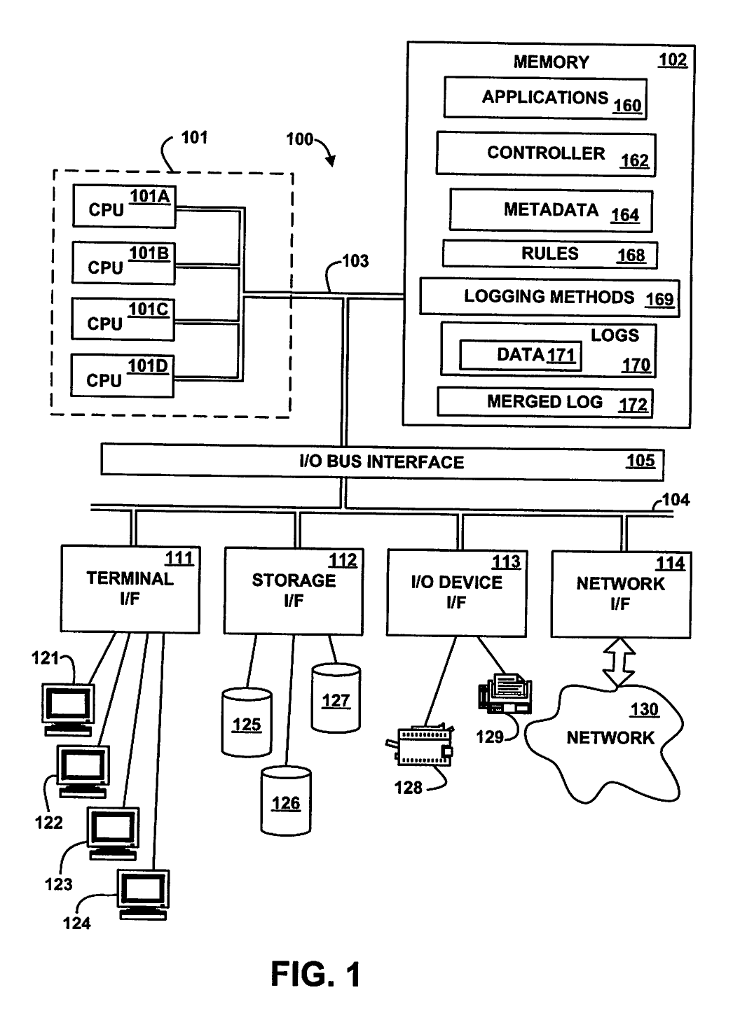

Referring to the Drawings, wherein like numbers denote like parts throughout the several views, FIG. 1 depicts a high-level block diagram representation of a computer system 100 connected to a network 130, according to an embodiment of the present invention. In an embodiment, the hardware components of the computer system 100 may be implemented by an eServer iSeries computer system available from International Business Machines of Armonk, N.Y. However, those skilled in the art will appreciate that the mechanisms and apparatus of embodiments of the present invention apply equally to any appropriate computing system.

The major components of the computer system 100 include one or more processors 101, a main memory 102, a terminal interface 111, a storage interface 112, an I/O (Input/Output) device interface 113, and communications/network interfaces 114, all of which are coupled for inter-component communication via a memory bus 103, an I/O bus 104, and an I/O bus interface unit 105.

The computer system 100 contains one or more general-purpose programmable central processing units (CPUs) 101A, 101B, 101C, and 101D, herein generically referred to as the processor 101. In an embodiment, the computer system 100 contains multiple processors typical of a relatively large system; however, in another embodiment the computer system 100 may alternatively be a single CPU system. Each processor 101 executes instructions stored in the main memory 102 and may include one or more levels of on-board cache.

In an embodiment, the main memory 102 is a random-access semiconductor memory for storing data and programs. In another embodiment, the main memory 102 represents the entire virtual memory of the computer system 100, and may also include the virtual memory of other computer systems coupled to the computer system 100 or connected via the network 130. The main memory 102 is conceptually a single monolithic entity, but in other embodiments the main memory 102 is a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may be further distributed and associated with different CPUs or sets of CPUs, as is known in any of various so-called non-uniform memory access (NUMA) computer architectures.

The memory 102 includes an application 160, a controller 162, metadata 164, rules 168, logging methods 169, logs 170, and a merged log 172. Although the application 160, the controller 162, the metadata 164, the rules 168, the logging methods 169, the logs 170, and the merged log 172 are illustrated as being stored within the memory 102 in the computer system 100, in other embodiments some or all of them may be on different computer systems and may be accessed remotely, e.g., via the network 130. The computer system 100 may use virtual addressing mechanisms that allow the programs of the computer system 100 to behave as if they only have access to a large, single storage entity instead of access to multiple, smaller storage entities. Thus, while the application 160, the controller 162, the metadata 164, the rules 168, the logging methods 169, the logs 170, and the merged log 172 are illustrated as being contained within the main memory 102, these elements are not necessarily all completely contained in the same storage device at the same time. Further, although the application 160, the controller 162, the metadata 164, the rules 168, the logging methods 169, the logs 170, and the merged log 172 are illustrated as being separate entities, in other embodiments some of them, or portions of some of them, may be packaged together.

The logs 170 include data 171. The application 160 responds to an event by creating the data 171 and sending a log request, the data 171, and a specification of a default logging method to the controller 162. In various embodiments, the application 160 may be a user application, a third-party application, an operating system, or any portion, combination, or multiple thereof. The application 160 may include instructions capable of executing on the processor 101 or statements capable of being interpreted by instructions executing on the processor 101 to create or collect the data 171 and send the data 171 to the controller 162. In another embodiment, the application 160 may be implemented in microcode. In another embodiment, the application 160 may be implemented in hardware via logic gates and/or other appropriate hardware techniques, in lieu of or in addition to a processor-based system.

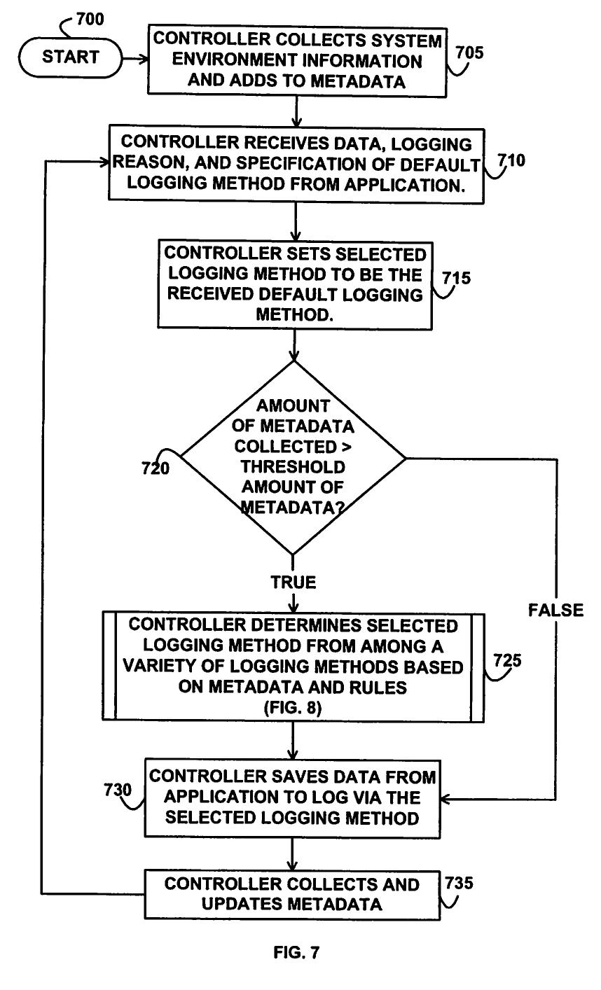

The controller 162 collects the metadata 164 and determines a selected logging method from among a variety of logging methods 169 based on the rules 168 and the metadata 164. The controller 162 then saves, writes, or logs the received data 171 to the log 170 via the selected logging method. The controller 162 also merges the logs 170 into a merged log 172. In an embodiment, the controller 162 includes instructions capable of executing on the processor 101 or statements capable of being interpreted by instructions executing on the processor 101 to perform the functions as further described below with reference to FIGS. 7, 8, and 9. In another embodiment, the controller 162 may be implemented in microcode. In another embodiment, the controller 162 may be implemented in hardware via logic gates and/or other appropriate hardware techniques, in lieu of or in addition to a processor-based system.

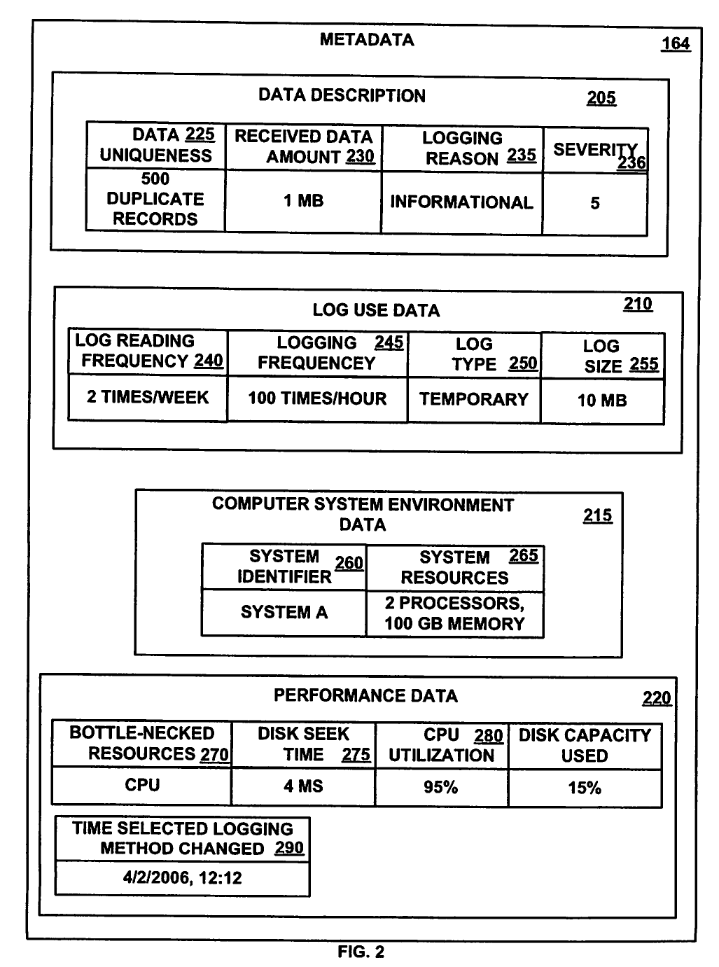

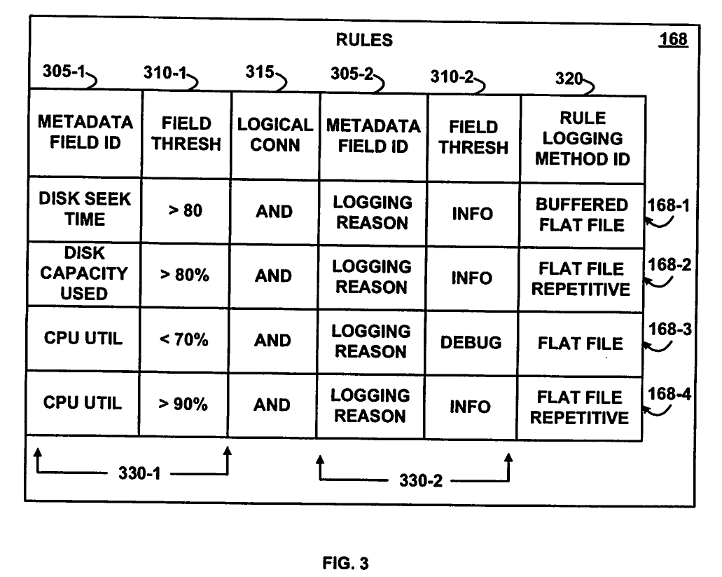

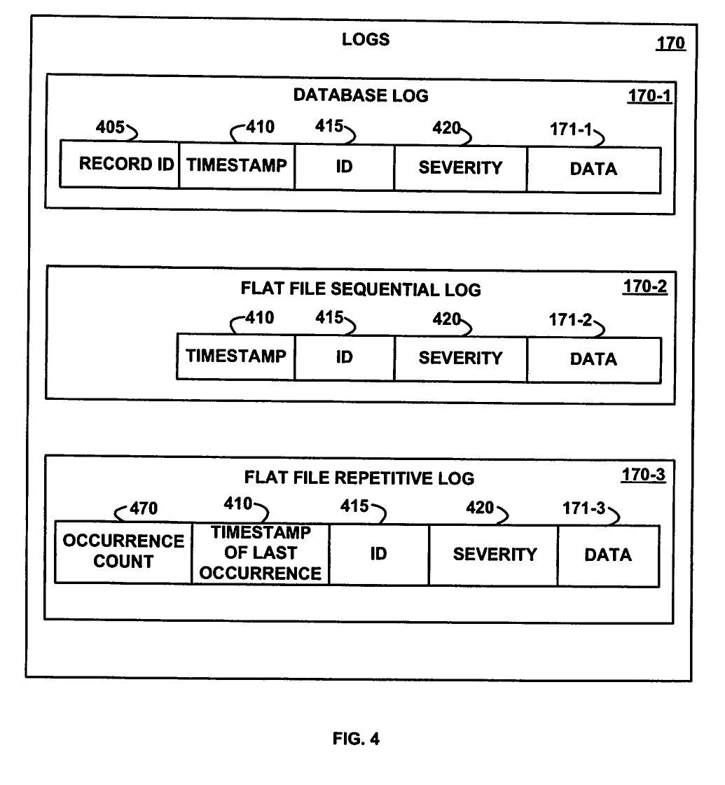

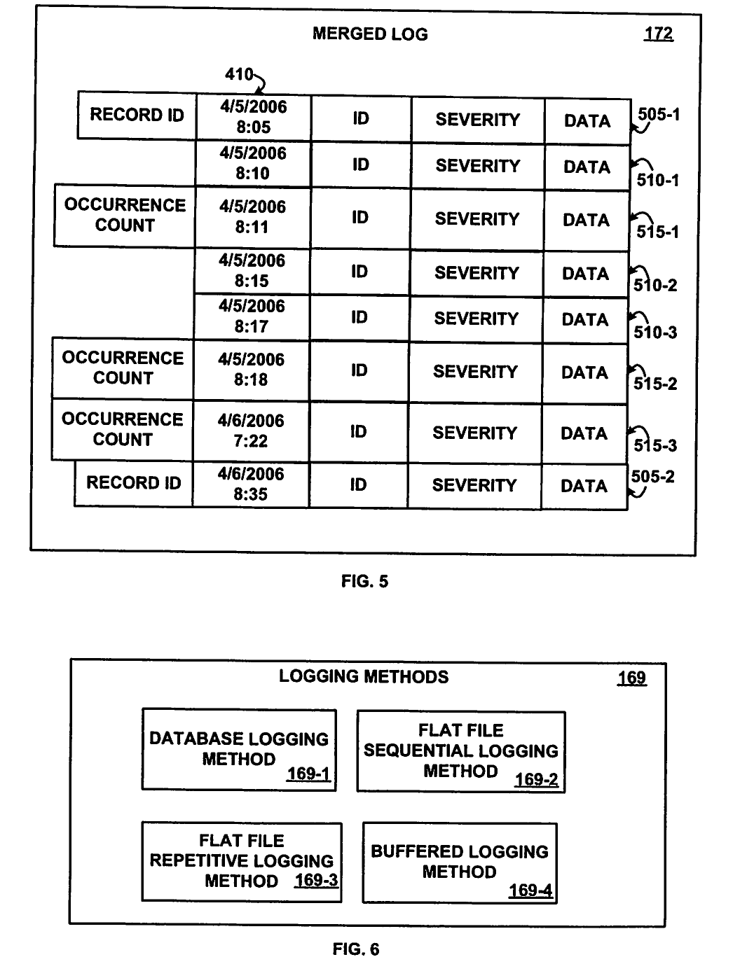

The metadata 164 is further described below with reference to FIG. 2. The rules 168 are further described below with reference to FIG. 3. The logs 170 are further described below with reference to FIG. 4. The merged log 172 contains merged records from the logs 170. The merged log 172 is further described below with reference to FIG. 5. The logging methods 169 are further described below with reference to FIG. 6.

The memory bus 103 provides a data communication path for transferring data among the processor 101, the main memory 102, and the I/O bus interface unit 105. The I/O bus interface unit 105 is further coupled to the system I/O bus 104 for transferring data to and from the various I/O units. The I/O bus interface unit 105 communicates with multiple I/O interface units 111, 112, 113, and 114, which are also known as I/O processors (IOPs) or I/O adapters (IOAs), through the system I/O bus 104. The system I/O bus 104 may be, e.g., an industry standard PCI (Peripheral Component Interconnect) bus, or any other appropriate bus technology.

The I/O interface units support communication with a variety of storage and I/O devices. For example, the terminal interface unit 111 supports the attachment of one or more user terminals 121, 122, 123, and 124. The storage interface unit 112 supports the attachment of one or more direct access storage devices (DASD) 125, 126, and 127 (which are typically rotating magnetic disk drive storage devices, although they could alternatively be other devices, including arrays of disk drives configured to appear as a single large storage device to a host). The contents of the main memory 102 may be stored to and retrieved from the direct access storage devices 125, 126, and 127, as needed.

The I/O device interface 113 provides an interface to any of various other input/output devices or devices of other types. Two such devices, the printer 128 and the fax machine 129, are shown in the exemplary embodiment of FIG. 1, but in other embodiment many other such devices may exist, which may be of differing types. The network interface 114 provides one or more communications paths from the computer system 100 to other digital devices and computer systems; such paths may include, e.g., one or more networks 130.

Although the memory bus 103 is shown in FIG. 1 as a relatively simple, single bus structure providing a direct communication path among the processors 101, the main memory 102, and the I/O bus interface 105, in fact the memory bus 103 may comprise multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 105 and the I/O bus 104 are shown as single respective units, the computer system 100 may in fact contain multiple I/O bus interface units 105 and/or multiple I/O buses 104. While multiple I/O interface units are shown, which separate the system I/O bus 104 from various communications paths running to the various I/O devices, in other embodiments some or all of the I/O devices are connected directly to one or more system I/O buses.

The computer system 100 depicted in FIG. 1 has multiple attached terminals 121, 122, 123, and 124, such as might be typical of a multi-user “mainframe” computer system. Typically, in such a case the actual number of attached devices is greater than those shown in FIG. 1, although the present invention is not limited to systems of any particular size. The computer system 100 may alternatively be a single-user system, typically containing only a single user display and keyboard input, or might be a server or similar device which has little or no direct user interface, but receives requests from other computer systems (clients). In other embodiments, the computer system 100 may be implemented as a personal computer, portable computer, laptop or notebook computer, PDA (Personal Digital Assistant), tablet computer, pocket computer, telephone, pager, automobile, teleconferencing system, appliance, or any other appropriate type of electronic device.

The network 130 may be any suitable network or combination of networks and may support any appropriate protocol suitable for communication of data and/or code to/from the computer system 100. In various embodiments, the network 130 may represent a storage device or a combination of storage devices, either connected directly or indirectly to the computer system 100. In an embodiment, the network 130 may support Infiniband. In another embodiment, the network 130 may support wireless communications. In another embodiment, the network 130 may support hard-wired communications, such as a telephone line or cable. In another embodiment, the network 130 may support the Ethernet IEEE (Institute of Electrical and Electronics Engineers) 802.3x specification. In another embodiment, the network 130 may be the Internet and may support IP (Internet Protocol).

In another embodiment, the network 130 may be a local area network (LAN) or a wide area network (WAN). In another embodiment, the network 130 may be a hotspot service provider network. In another embodiment, the network 130 may be an intranet. In another embodiment, the network 130 may be a GPRS (General Packet Radio Service) network. In another embodiment, the network 130 may be a FRS (Family Radio Service) network. In another embodiment, the network 130 may be any appropriate cellular data network or cell-based radio network technology. In another embodiment, the network 130 may be an IEEE 802.11B wireless network. In still another embodiment, the network 130 may be any suitable network or combination of networks. Although one network 130 is shown, in other embodiments any number (including zero) of networks (of the same or different types) may be present.

It should be understood that FIG. 1 is intended to depict the representative major components of the computer system 100 and the network 130 at a high level, that individual components may have greater complexity than represented in FIG. 1, that components other than or in addition to those shown in FIG. 1 may be present, and that the number, type, and configuration of such components may vary. Several particular examples of such additional complexity or additional variations are disclosed herein; it being understood that these are by way of example only and are not necessarily the only such variations.

The various software components illustrated in FIG. 1 and implementing various embodiments of the invention may be implemented in a number of manners, including using various computer software applications, routines, components, programs, objects, modules, data structures, etc., referred to hereinafter as “computer programs,” or simply “programs.” The computer programs typically comprise one or more instructions that are resident at various times in various memory (e.g., the memory 102) and storage devices (e.g., the devices 125, 126, and 127) in the computer system 100, and that, when read and executed by one or more processors 101 in the computer system 100, cause the computer system 100 to perform the steps necessary to execute steps or elements comprising the various aspects of an embodiment of the invention.

Moreover, while embodiments of the invention have and hereinafter will be described in the context of fully-functioning computer systems, the various embodiments of the invention are capable of being distributed as a program product in a variety of forms, and the invention applies equally regardless of the particular type of signal-bearing medium used to actually carry out the distribution. The programs defining the functions of this embodiment may be delivered to the computer system 100 via a variety of tangible signal-bearing media that may be operatively or communicatively connected (directly or indirectly) to the processor 101. The signal-bearing media may include, but are not limited to:

(1) information permanently stored on a non-rewriteable storage medium, e.g., a read-only memory device attached to or within a computer system, such as a CD-ROM readable by a CD-ROM drive;

(2) alterable information stored on a rewriteable storage medium, e.g., a hard disk drive (e.g., DASD 125, 126, or 127), CD-RW, DVD, or diskette; or

(3) information conveyed to the computer system 100 by a communications medium, such as through a computer or a telephone network, e.g., the network 130.

Such tangible signal-bearing media, when encoded with or carrying computer-readable and executable or interpretable instructions that direct the functions of the present invention, represent embodiments of the present invention.

Embodiments of the present invention may also be delivered as part of a service engagement with a client corporation, nonprofit organization, government entity, internal organizational structure, or the like. Aspects of these embodiments may include configuring a computer system to perform, and deploying software systems and web services that implement, some or all of the methods described herein. Aspects of these embodiments may also include analyzing the client company, creating recommendations responsive to the analysis, generating software to implement portions of the recommendations, integrating the software into existing processes and infrastructure, metering use of the methods and systems described herein, allocating expenses to users, and billing users for their use of these methods and systems.

In addition, various programs described hereinafter may be identified based upon the application for which they are implemented in a specific embodiment of the invention. But, any particular program nomenclature that follows is used merely for convenience, and thus embodiments of the invention should not be limited to use solely in any specific application identified and/or implied by such nomenclature.

The exemplary environments illustrated in FIG. 1 are not intended to limit the present invention. Indeed, other alternative hardware and/or software environments may be used without departing from the scope of the invention.

FIG. 2 depicts a block diagram of example metadata 164, according to an embodiment of the invention. The metadata 164 includes a data description 205, log use data 210, computer system environment data 215, and performance data 220.

The data description 205 describes the data 171 that the controller 162 has received from the application 160 and that is saved to the log. The data description 205 includes a data uniqueness field 225, a received data amount field 230, a logging reason field 235, and a severity field 236. The data uniqueness field 225 describes the degree to which the data 171 the controller 162 has saved to the log 170 is unique. In an embodiment, the data uniqueness field 225 indicates the number of duplicate records (having completely or partially identical data 171) in the log 170. The received data amount field 230 indicates the amount of data 171 that the controller 162 has received from the application 160, which the application 160 requested the controller 162 to save to the log 170. The logging reason 235 indicates the data type of the data 171 or the reason that the application 160 requests the data 171 to be saved to the log 170. In various embodiments, the logging reason 235 may characterize the data 171 as informational, an error, an exception, a trace, or a status or any other appropriate type of data or reason for logging the data. The severity field 236 indicates the severity of the data 171, for example, the data 171 may need urgent attention or may not need any present attention, but is only saved for future reference on an as-needed basis. In various embodiment, the severity 236 may be represented on a relative or absolute numerical scale or may be a textual or keyword description.

The log use data 210 describes the use of the log 170 by the application 160 and/or by a viewer or user of the log 170. The log use data 210 includes a log reading frequency field 240, a logging frequency field 245, a log type field 250, and a log size field 255. The log reading frequency field 240 indicates the number of times that the data 171 has been viewed or read from the log 170. The logging frequency field 245 indicates the number of times or how often that data 171 has been written to the log 170. The log type field 250 indicates the type of the log, such as temporary, permanent, read only, write only, non-critical, critical, multi-user access, or any other type. The log size field 255 indicates the amount of data 171 that has been written to the log.

The computer system environment data 215 describes the computer 100 and the resources of the computer 100, in which the saving of the data 171 to the log is performed via the controller 162 and the logging methods 169. The computer system environment data 215 includes a system identifier field 260 and a system resources field 265. The system identifier field 260 identifies the computer 100. The system resources field 265 identifies resources in or associated with the computer 100, in which the saving of the data 171 to the log 170 is performed. The system resources 265 may identify the processor 101, the memory 102, the memory bus 103, the I/O bus 104, the I/O bus interface 105, the terminal interface 111, the storage interface 112, the I/O device interface 113, the network interface 114, the terminals 121, 122, 123, and 124, the storage devices 125, 126, and 127, the printer 128, the fax machine 129, the network 130 or any other appropriate resource. The system resources may further indicate amounts of storage, processor speeds, and any other appropriate attributes of the resources.

The performance data 220 includes performance statistics for the computer 100, in which the saving of the data 171 to the log is performed. The performance data 220 includes a bottle-necked resources field 270, a disk seek time field 275, a CPU utilization field 280, a disk capacity used field 285, and a time of selected logging method change field 290. The bottle-necked resources field 270 identifies any of the system resources 265 that are constrained or nearing capacity. The disk seek time field 275 indicates the average or median amount of time that a disk head takes to move from its current location to a specific location on a storage device. The CPU utilization field 280 indicates the percentage of time that the processor 101 is busy. The disk capacity used field 285 indicates the amount or percentage of the storage devices 125, 126, and 127 that are used. The time that the selected logging method changed field 290 indicates the date and/or time that the selected logging method used to saved the data 171 to the log 170 changed. In other embodiments, the performance data 220 may include additional items, such as transfer time, response time, rotational delay, transaction rates, or any other appropriate performance statistics.

FIG. 3 depicts a block diagram of the rules 168, according to an embodiment of the invention. The rules 168 include example rules 168-1, 168-2, 168-3, and 168-4. Each of the rules 168-1, 168-2, 168-3, and 168-4 includes any number of example metadata field identifiers, such as the metadata field identifiers 305-1 and 305-2. The metadata field identifiers 305-1 and 305-2 specify respective fields in the metadata 164, such as the data uniqueness 225, the received data amount 230, the logging reason 235, the severity 236, the log reading frequency 240, the logging frequency 245, the log type 250, the log size 255, the system identifier 260, the system resources 265, the bottle-necked resources 270, the disk seek time 275, the CPU utilization 280, or the disk capacity used 285.

Each of the rules 168-1, 168-2, 168-3, and 168-4 further includes any number of field thresholds, such as the field thresholds 310-1 and 310-2. The field thresholds 310-1 and 310-2 correspond to their respective metadata field identifiers 305-1 and 305-2 and specify respective thresholds for the values in the fields in the metadata 164 that are identified by the metadata field identifiers 305-1 and 305-2. A metadata field identifier and its corresponding field threshold form a statement in a rule. For example, the metadata field identifier 305-1 and the field threshold 310-1 form the statement 330-1, and the metadata field identifier 305-2 and the field threshold 310-2 form the statement 330-2.

The logical connector 315 specifies the logical relationship between the statements 330-1 and 330-2 of the rule. In various embodiments, the logical connector 315 may be an “and” connector, an “or” connector, a “not” connector, or any other appropriate logical connector. Although each of the rules 168-1, 168-2, 168-3, and 168-4 is illustrated as including a logical connector 315 that connects statements, in another embodiment the logical connector 315 is not present. The combination of the statements 330-1 and 330-2 and the logical connector 315 forms a logical expression, the truth or falsehood of which the controller 162 evaluates to determine whether the metadata 164 satisfies the rule. Each of the rules 168-1, 168-2, 168-3, and 168-4 further includes an example rule logging method identifier 320, each of which identifies one of the logging methods 169.

Thus, the controller 162 evaluates whether the metadata field identified by the metadata field identifier 305-1 contains a value that satisfies the field threshold 310-1, the controller 162 evaluates whether the metadata field identified by the metadata field identifier 305-2 meets the field threshold 310-2, and the controller 162 evaluates the truth or falsehood of the logical expression formed by the statement 330-1, the statement 330-2, and the logical connector 315. If the metadata 164 satisfies the logical expression formed by the statement 330-1, the statement 330-2, and the logical connector 315, then the controller 162 sets the selected logging method to be the logging method 169 identified by the rule logging method identifier 320.

For example, the controller 162 evaluates the rule 168-1 by determining the truth or falsehood of the statement 330-1, i.e., whether the disk seek time field 275 in the metadata 164 identified by the metadata field identifier 305-1 meets the field threshold of “>80” in the field threshold 310-1. The controller 162 further evaluates the rule 168-1 by determining the truth or falsehood of the statement 330-2, i.e., whether the logging reason 235 in the metadata 164 identified by the metadata field identifier 305-1 meets the field threshold of “informational” in the field threshold 310-2. The controller 162 further evaluates the rule 168-1 by determining the truth or falsehood of the logical expression formed by the truth or falsehood of the statement 330-1 (whether or not the disk seek time is greater than 80) and (“and” is the logical connector 315 in the rule 168-1) the truth or falsehood of the statement 330-2 (whether or not the logging reason is informational). Thus, if the controller 162 determines that the disk seek time is greater than 80 and the logging reason is informational, then the controller 162 sets the selected logging method to be the rule logging method of a buffered flat file.

FIG. 4 depicts a block diagram of the example logs 170, according to an embodiment of the invention. The database log 170-1, the flat file sequential log 170-2, and the flat file repetitive log 170-3 are all examples of the log 170.

The database log 170-1 stores the logged data in a database, which is typically implemented as rows and columns with an index. The database log 170-1 includes records of logged data, each of which includes a record identifier 405, a timestamp 410, an identifier of the logged data 415, a severity 420, and the data 171-1, which is an example of the data 171 (FIG. 1). In an embodiment, the database log 170-1 is used to store historical, permanent, read/write data in large quantities where multi-user access via searching and queries to the data is important.

The flat file sequential log 170-2 includes records of logged data, each of which includes a timestamp 410, an identifier of the logged data 415, a severity 420, and the data 171-2, which is an example of the data 171 (FIG. 1). In an embodiment, the flat file sequential log 170-2 is used to store both permanent and temporary data where the data is more commonly written to the log than read from the log, and fewer users access the log than access the database log 170-1.

The flat file repetitive log 170-3 includes records of logged data, each of which includes an occurrence count 470, a timestamp of the last occurrence 410, a record identifier 405, a timestamp 410, an identifier of the logged data 415, a severity 420, and the data 171-3, which is an example of the data 171 (FIG. 1). The occurrence count 470 is the number of times that the duplicate data was received, and only one occurrence of the data is stored in the log 170-3. In an embodiment, the flat file repetitive log 170-3 is used to store data that may be received multiple times from the application 160. Thus, the flat file repetitive log 170-3 stores duplicate data in one record with a count of the number of times the duplicate data was received.

The different logs 170-1, 170-2, and 170-3 may have different formats, such as different numbers, types, and orders of fields. For example, the database log 170-1 has a record identifier field 405 while the flat file sequential log 170-2 and the flat file repetitive log 170-3 do not. As another example, the flat file repetitive log 170-3 has an occurrence count 470 while the database log 170-1 and the flat file sequential log 170-2 do not. The logs 170-1, 170-2, and 170-3 also are accessed via different logging methods 169, as further described below with reference to FIG. 6.

FIG. 5 depicts a block diagram of an example merged log 172, according to an embodiment of the invention. The controller 162 creates the merged log 172 by merging records from the logs 170-1, 170-2, and 170-3, which have different formats. The different formats of the records from the different logs 170-1, 170-2, and 170-3 are maintained in the merged log 172. Thus, the records in the merged log 172 may have different fields, different numbers of fields, and/or a different order for the fields in the various records.

The merged log 172 includes records 505-1, 505-2, 510-1, 510-2, 510-3, 515-1, 515-2, and 515-3. The controller 162 merged the records 505-1 and 505-2 into the merged log 172 from the database log 170-1. The controller 162 merged the records 510-1, 510-2, and 510-3 from the flat file sequential log 170-2. The controller 162 merged the records 515-1, 515-2, and 515-3 from the flat file repetitive log 170-3. The controller 162 sorts the records 505-1, 505-2, 510-1, 510-3, 515-1, 515-2, and 515-3 in the merged log 172 by chronological order, interleaving the records from the various logs 170 according to their timestamp fields.

FIG. 6 depicts a block diagram of example logging methods 169, according to an embodiment of the invention. The example logging methods 169 include a database logging method 169-1, a flat file sequential logging method 169-2, a flat file repetitive logging method 169-3, and a buffered logging method 169-4.

The logging methods 169-1, 169-2, and 169-3 create records in the respective logs 170-1, 170-2, and 170-3 (FIG. 4). The buffered logging method 169-4 temporarily saves the data 171 in a buffer in the memory 102 and periodically writes the buffered data 171 at a later time to the log 170. The buffered logging method 169-4 may use any or all of the logs 170-1, 170-2, or 170-3. The buffered logging method 169-4 may invoke, call, or send messages to the other logging methods 169-1, 169-2, and 169-3 in order to write or save the buffered data to the logs 170-1, 170-2, and 170-3.

In an embodiment, the logging methods 169-1, 169-2, 169-3, and 169-4 represent APIs (Application Program Interfaces) that the controller 162 invokes, calls, or sends messages or requests to, in order to save or write the data 171 to the logs 170. In another embodiment, the logging methods 169 include executable instructions that execute on the processor 101 or statements interpreted by instructions that execute on the processor 101 to save or write the data 171 to the logs 170. In another embodiment, the logging methods 169 may be implemented in microcode or hardware.

FIG. 7 depicts a flowchart of example processing for the controller 162, according to an embodiment of the invention. Control begins at block 700. Control then continues to block 705 where the controller 162 collects the system environment data 215 from the computer 100 and adds system environment data 215 to the metadata 164. In various embodiments, the controller 162 may interrogate the resources of the computer 100 for the data or may retrieve data from a service processor, from vital product data (VPD), from other data structures of the computer 100, or from a remote server connected via the network 130. Control then continues to block 710 where the controller 162 receives the data 171, a reason for the logging request or a type of the data 171, and a specification of a default logging method from the application 160. The specification of the default logging method identifies one of the logging methods 169 and may also specify one of the logs 170. Control then continues to block 715 where the controller 162 sets the selected logging method to be the received default logging method.

Control then continues to block 720 where the controller 162 determines whether the amount of the metadata 164 collected thus far is greater than a threshold amount of the metadata 164. In various embodiments, the amount of metadata collected thus far may reflect the number of logging requests received from the application 160 that are described in the metadata 164, the number of the fields in the metadata 164 that contain data values, or the amount (the size) of the data 171 that is described by the metadata 164.

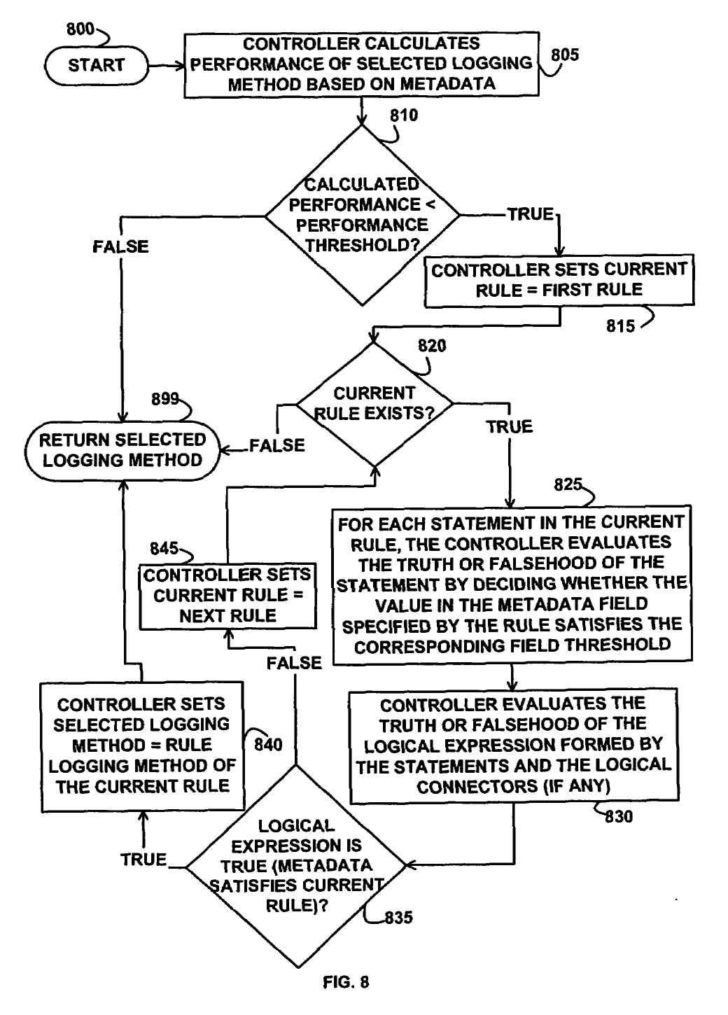

If the determination at block 720 is true, then the amount of the metadata 164 collected thus far is greater than a threshold amount of the metadata 164, so control continues to block 725 where the controller 162 determines the selected logging method from among the multiple logging methods 169 based on the metadata 164 and the rules 168, as further described below with reference to FIG. 8. Control then continues to block 730 where the controller 162 saves the data 171 that was received from the application 160 to the log via the selected logging method, e.g., via calling, invoking, or sending a request or message to the selected logging method of the logging methods 169. Control then continues to block 735 where the controller 162 collects and updates the metadata 164 based on the received data 171, the resources of the computer system 100, the performance of the computer system 100, and the use of the log 170. The controller 162 then returns to block 710 where the controller 162 receives more data 171, another logging reason, and specification of another default logging method from the application 160, as previously described above.

If the determination at block 720 is false, then the amount of the metadata 164 collected thus far is not greater than a threshold amount of the metadata 164, so control continues to block 730 where the controller 162 saves the data 171 that was received from the application 160 to the log 170 via the selected logging method, which in this case is the received default logging method. Control then continues to block 735, as previously described above.

FIG. 8 depicts a flowchart of example processing for selecting a selected logging method by the controller 162, according to an embodiment of the invention. Control begins at block 800. Control then continues to block 805 where the controller 162 calculates the performance of the selected logging method based on the metadata 164. In an embodiment, the controller 162 calculates the performance of the computer system during the time interval since the selected logging method last was changed based on the performance data 220 in the metadata 164. The controller 162 determines the time interval since the selected logging method changed by calculating the difference between the current date and time and the date and time specified in the time the selected logging method changed field 290 in the metadata 164.

Control then continues to block 810 where the controller 162 determines whether the calculated performance of the computer system 100 since the selected logging method was last changed is less than a performance threshold.

If the determination at block 810 is true, then the calculated performance of the current selected logging method is less than the performance threshold, so control continues to block 815 where the controller 162 sets the current rule to be the first rule in the rules 168. Control then continues to block 820 where the controller 162 determines whether the current rule exists (whether a rule is yet unprocessed by the logic of FIG. 8).

If the determination at block 820 is true, then the current rule exists and is unprocessed by the logic of FIG. 8, so control continues to block 825 where the controller 162 evaluates the truth or falsehood of each statement in the current rule by deciding whether the value in the respective metadata field specified by the rule 168 satisfies the corresponding field threshold in the rule 168. Control then continues to block 830 where the controller 162 evaluates the truth or falsehood of the logical expression formed by the statement or statements and any logical connectors that connect the statements. Control then continues to block 835 where the controller 162 determines whether the logical expression of the current rule is true (i.e., whether the metadata 164 satisfies or meets the current rule).

If the determination at block 835 is true, then the logical expression of the current rule is true (the metadata values that are in the fields specified by the current rule satisfy the field thresholds and any logical connector specified by the current rule), so control continues to block 840 where the controller 162 sets the selected logging method to be the particular logging method 169 specified by the rule logging method identifier 320 of the current rule. The controller 162 further saves the current time into the time the selected logging method changed field 290 of the metadata 164. Thus, the controller 162 selects a different selected logging method at block 840 from the previous selected logging method (the logging method that was the selected method at block 805) if the performance of the selected logging method is lower than the performance threshold (at block 810).

Control then continues to block 899 where the logic of FIG. 8 returns the selected logging method to the invoking logic of FIG. 7.

If the determination at block 835 is false, then the logical expression of the current rule is false (the metadata values that are in the fields specified by the current rule do not satisfy the field thresholds and the logical connector (if any) specified by the current rule), so control continues to block 845 where the controller 162 sets the current rule to be the next rule in the rules 168. Control then returns to block 820 where the controller 162 determines whether the new current rule exists, as previously described above.

If the determination at block 820 is false, then the current rule does not exist, and all of the rules 168 have been processed by the logic of FIG. 8, so control continues to block 899 where the logic of FIG. 8 returns the selected logging method to the invoking logic of FIG. 7.

If the determination at block 810 is false, then the calculated performance of the computer system 100 while the controller 162 was using the current selected logging method is not less than the performance threshold, so control continues to block 899 where the logic of FIG. 8 returns to the invoking logic of FIG. 7 without changing the current selected logging method.

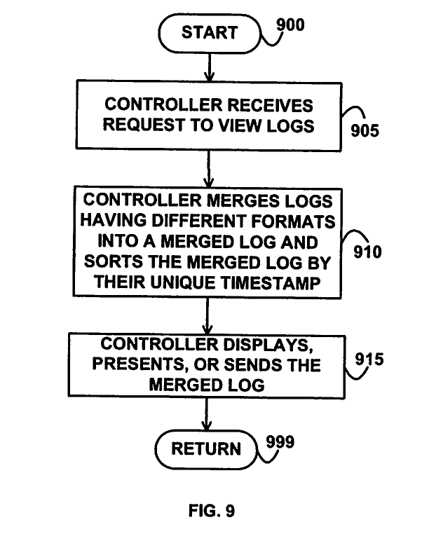

FIG. 9 depicts a flowchart of further example processing for merging and displaying logs 170 by the controller 162, according to an embodiment of the invention. Control begins at block 900. Control then continues to block 905 where the controller 162 receives a request (e.g., from a user, the application 160, or any other program) to view the logs 170. Control then continues to block 910 where the controller 162 merges the logs 170 together to create a merged log 172. The controller 162 sorts the records in the merged log 172 by their unique timestamp values 410, so that the records in the merged log 172 are in chronological order. Control then continues to block 915 where the controller 162 displays the merged log 172, e.g., via one or more of the terminals 121, 122, 123, or 124, presents the merged log 172 via a printer, speaker, or other output device, or sends the merged log 172 to a destination, e.g., via the network 130. Control then continues to block 999 where the logic FIG. 9 returns.

In the previous detailed description of exemplary embodiments of the invention, reference was made to the accompanying drawings (where like numbers represent like elements), which form a part hereof, and in which is shown by way of illustration specific exemplary embodiments in which the invention may be practiced. These embodiments were described in sufficient detail to enable those skilled in the art to practice the invention, but other embodiments may be utilized and logical, mechanical, electrical, and other changes may be made without departing from the scope of the present invention. In the previous description, numerous specific details were set forth to provide a thorough understanding of embodiments of the invention. But, the invention may be practiced without these specific details. In other instances, well-known circuits, structures, and techniques have not been shown in detail in order not to obscure the invention. Different instances of the word “embodiment” as used within this specification do not necessarily refer to the same embodiment, but they may.

Any data, data values, data structures, and names or identifiers of fields or data structures illustrated or described herein are examples only, and in other embodiments, different names, identifiers, amounts of data, data values, types of data, fields, numbers and types of fields, field names, data structure names, numbers and types of rows, records, entries, or organizations of data may be used. In addition, any data may be combined with logic, so that a separate data structure is not necessary. The previous detailed description is, therefore, not to be taken in a limiting sense, and the scope of the present invention is defined only by the appended claims.

What is claimed is:

1. A method comprising:
receiving data and a specification of a default logging method from an application;
collecting metadata, wherein the metadata describes the data;
determining whether the collecting has collected more than a threshold amount of the metadata;
if the determining is false, saving the data via the default logging method; and
if the determining is true, selecting a selected logging method from among a plurality of logging methods based on the metadata, and saving the data via the selected logging method.

2. The method of claim 1, wherein the selecting further comprises:
selecting the selected logging method based on the metadata and a plurality of rules, wherein each of the plurality of rules identifies a field in the metadata, a field threshold, and a rule logging method.

3. The method of claim 2, wherein the selecting further comprises:
deciding whether a value in the field in the metadata satisfies the field threshold in the rule;
if the deciding is true, setting the selected logging method to be the rule logging method; and
if the deciding is false, choosing a different rule from the plurality of rules and re-performing the deciding on the different rule.

4. The method of claim 3, wherein at least one of the plurality of rules further comprises:
a plurality of identifiers of a plurality of the fields in the metadata, a plurality of the field thresholds, and at least one logical connecter between the plurality of identifiers.

5. The method of claim 4, wherein the selecting further comprises:
evaluating truth of a logical expression formed by the plurality of identifiers of the fields, the plurality of field thresholds, and the at least one logical connector.

6. The method of claim 1, further comprising:
calculating performance of the selected logging method based on the metadata; and
selecting a different selected logging method if the performance of the selected logging method is lower than a performance threshold.

7. The method of claim 1, wherein the metadata further describes resources of a computer in which the saving is performed.

8. The method of claim 1, wherein the metadata further comprises performance data of a computer in which the saving is performed.

9. The method of claim 1, wherein the metadata further comprises a reason for the saving of the data.

10. A signal-bearing medium encoded with instructions, wherein the instructions when executed comprise:
receiving data and a specification of a default logging method from an application;
collecting metadata, wherein the metadata describes the data;
determining whether the collecting has collected more than a threshold amount of the metadata;
if the determining is false, saving the data via the default logging method; and
if the determining is true, selecting a selected logging method from among a plurality of logging methods based on the metadata, and saving the data via the selected logging method, wherein the selecting further comprises selecting the selected logging method based on the metadata and a plurality of rules, wherein each of the plurality of rules identifies a field in the metadata, a field threshold, and a rule logging method.

11. The signal-bearing medium of claim 10, wherein the selecting further comprises:
deciding whether a value in the field in the metadata satisfies the field threshold in the rule;
if the deciding is true, setting the selected logging method to be the rule logging method; and
if the deciding is false, choosing a different rule from the plurality of rules and re-performing the deciding on the different rule.

12. The signal-bearing medium of claim 11, wherein at least one of the plurality of rules further comprises:
a plurality of identifiers of a plurality of the fields in the metadata, a plurality of the field thresholds, and at least one logical connecter between the plurality of identifiers.

13. The signal-bearing medium of claim 12, wherein the selecting further comprises:
evaluating truth of a logical expression formed by the plurality of identifiers of the fields, the plurality of field thresholds, and the at least one logical connector.

14. The signal-bearing medium of claim 10, further comprising:
calculating performance of the selected logging method based on the metadata.

15. The signal-bearing medium of claim 14, further comprising:
selecting a different selected logging method if the performance of the selected logging method is lower than a performance threshold.

16. A method for configuring a computer, comprising:
configuring the computer to receive data and a specification of a default logging method from an application;
configuring the computer to collect metadata, wherein the metadata describes the data;
configuring the computer to determine whether the collecting has collected more than a threshold amount of the metadata;
configuring the computer to, if the determining is false, save the data via the default logging method;
configuring the computer to, if the determining is true, select a selected logging method from among a plurality of logging methods based on the metadata, and save the data via the selected logging method, wherein the selecting further comprises selecting the selected logging method based on the metadata and a plurality of rules, wherein each of the plurality of rules identifies a field in the metadata, a field threshold, and a rule logging method; and
configuring the computer to merge a plurality of logs created by the plurality of the respective logging methods into a merged log, wherein the plurality of the logs have a plurality of respective formats.

17. The method of claim 16, wherein the configuring the computer to select further comprises:
configuring the computer to decide whether a value in the field in the metadata satisfies the field threshold in the rule;
configuring the computer to, if the deciding is true, set the selected logging method to be the rule logging method; and
configuring the computer to, if the deciding is false, choose a different rule from the plurality of rules and re-performing the deciding on the different rule.

18. The method of claim 17, wherein at least one of the plurality of rules further comprises:
a plurality of identifiers of a plurality of the fields in the metadata, a plurality of the field thresholds, and at least one logical connecter between the plurality of identifiers.

19. The method of claim 18, wherein the configuring the computer to select further comprises:
configuring the computer to evaluate truth of a logical expression formed by the plurality of identifiers of the fields, the plurality of field thresholds, and the at least one logical connector.

20. The method of claim 16, further comprising:
configuring the computer to calculate performance of the selected logging method based on the metadata; and
configuring the computer to select a different selected logging method if the performance of the selected logging method is lower than a performance threshold.
